(19) United States
(12) Patent Application Publication
(10) Pub. No.: US 2014/0090662 A1
(43) Pub. Date: Apr. 3, 2014

(54) FLOSSING TOOL

(71) Applicants: Keith B. Allen, Woodland Hills, CA (US); Jeromi K. Stewart, Los Angeles, CA (US); Thomas W. Nabors, Nashville, TN (US); Dan Grauer, Santa Monica, CA (US)

(72) Inventors: Keith B. Allen, Woodland Hills, CA (US); Jeromi K. Stewart, Los Angeles, CA (US); Thomas W. Nabors, Nashville, TN (US); Dan Grauer, Santa Monica, CA (US)

(73) Assignee: ORALWISE, INC, Dallas, TX (US)

(21) Appl. No.: 14/044,598

(22) Filed: Oct. 2, 2013

Related U.S. Application Data
(60) Provisional application No. 61/708,886, filed on Oct. 2, 2012.

(51) Int. Cl. A61C 15/04

(52) U.S. Cl. CPC A61C 15/048
USPC 132/323

(57) ABSTRACT

A flossing kit and tool include a floss cartridge having a length of floss and a pair of tip members each sized larger than a typical spacing behind arch wires of a set of braces, each fixedly coupled to opposite ends of the length of floss. Each tip member includes a coupling structure and a projection member and are coupled to the length of floss, wherein the projection member of at least one of the tip members is elongated and sufficiently narrow to be inserted into a typical spacing behind arch wires of a set of braces. The flossing tool includes a pair of floss handles each removably couple to one of the pair of tip members respectively. The flossing tool includes a release mechanism disposed within the cylindrical body that selectably couples and disengages from the associated coupling structure of the tip member when triggered.

### CROSS-REFERENCE TO RELATED APPLICATIONS

This invention claims priority, under 35 U.S.C. §120, to the U.S. Provisional Patent Application No. 61/708,886 to Keith B. Allen et al. filed on Oct. 2, 2012, which is incorporated by reference herein.

### BACKGROUND OF THE INVENTION

1. Field of the Invention

The present invention relates to dental hygiene devices, specifically an orthodontic dental flossing tool.

2. Description of the Related Art

Dental floss is a bundle of thin filaments used to remove food and dental plaque from teeth. The floss is gently inserted between the teeth and scraped along the teeth sides, especially close to the gums or underneath them. Dental floss may be made of either plastic (nylon, PTFE or polyethylene) or silk, and can be flavored or unflavored, and waxed or unwaxed. An alternative tool to achieve the same effect is the interdental brush.

Dental floss is held between the fingers or strung on a fork-like instrument. The floss is guided between each tooth and under the gumline to remove particles of food stuck between teeth anddento-bacterial plaque that adhere to such dental surfaces. Ideally using a C-shape, the floss is curved around a tooth and placed under the gumline, and then moved away from the gumline, the floss scrapes the side of each tooth, and can also clean the front or back of the tooth. Gently moving the floss from below the gumline to away from the gumline removes dento-bacterial plaque attached to teeth surfaces above and below the gumline. A clean section of floss can be used to clean each tooth to avoid transmitting plaque bacteria from one tooth to another.

Specialized plastic wands, or floss picks, have been produced to hold the floss. These may be attached to or separate from a floss dispenser. While wands do not pinch fingers like regular floss can, using a wand may be awkward and can also make it difficult to floss at all the angles possible with regular floss. These types of flossers also run the risk of missing the area under the gum line that needs to be flossed. On the other hand, the enhanced reach of a wand can make flossing the back teeth easier.

A floss pick is a disposable oral hygiene device generally made of plastic and dental floss. The instrument is composed of two prongs extending from a thin plastic body of high-impactpolystyrene material. A single piece of floss runs between the two prongs. The body of the floss pick generally tapers at its end in the shape of a toothpick.

There are two types of angled floss picks in the oral care industry, the ‘Y’-shaped angle and the ‘F’-shaped angle floss pick. At the base of the arch where the ‘y’ begins to branch there is a handle for gripping and maneuvering before it tapers off into a pick. Floss picks are manufactured in a variety of shapes, colors and sizes for adults and children. The floss can be coated in fluoride, flavor or wax.

Some improvements have been made in the field. Examples of references related to the present invention are described below in their own words, and the supporting teachings of each reference are incorporated by reference herein:

U.S. Pat. No. 4,597,398, issued to Chu, discloses an instrument for promoting oral hygiene particularly with patients having orthodontial appliances. An elongate handle includes a short hollow post at the distal end thereof disposed generally transverse to the handle. Flossing material is threaded through and out the post. In operation, the post is disposed by means of the handle between the orthodontial band and adjacent the spacing between teeth which are desired to be cleaned. The floss protruding out the post is then forced between the spacing to effect flossing thereof.

U.S. Pat. No. 8,146,608, issued to Chung, discloses a dental floss holding structure includes a dental floss and two holding bodies. The two ends of the dental floss are respectively connected with a base, which includes a first coupling portion with a first positioning portion mounted thereon. Each of the two holding bodies includes a second coupling portion corresponding to the first coupling portion, and the second coupling portion has a second positioning portion corresponding to the first positioning portion, so that the dental floss and the holding bodies can be stably fixed with each other through the engagement between the first and the second positioning portions. Accordingly, when the user's hands hold the two holding bodies to clean the teeth slits, the fingers can be kept out of the mouth without entering the mouth, which not only provides convenience but also assures the hygiene.

U.S. Pat. No. 8,061,372, issued to Allen, discloses an orthodontic flossing implement for facilitating positioning and manipulating of a portion of a length of dental floss into the interdental space between adjacent teeth and proximate to and beneath an orthodontic wire which defines an arch extending between adjacent orthodontic brackets on the teeth. An elongated handle dependently supports an elongated, slender shaft formed as a unit with, and extending from a proximal end of the handle. The shaft is dimensionally smaller in thickness than that of said handle and preferably oriented at an acute angle to the handle. A tip, formed as a unit with, and extending from a second end of the shaft, is oriented at an acute angle to the handle, the tip having an aperture formed therethrough sized to just receive a length of dental floss. The tip with the dental floss positioned through said aperture, is manipulable by said handle to pass beneath an arch of the orthodontic wire and to floss the interdental tissue.

U.S. Pat. No. 7,464,716, issued to Nygren Jr., discloses an electric flossing apparatus comprising a flossing head which is detachably connected to a handle containing a reciprocating drive unit, a non-powered second handle to allow for the increased controllability of two-handed powered flossing and a disposable floss assembly that can be easily be attached to or released from the flossing head and handle. The floss is releasably attached to the flossing head in a manner that allows reciprocating motion to be imparted along the length of the floss no matter which direction that the floss exits the end of the flossing head or the shape of the path it takes. By using both hands for flossing the floss may be pulled straight and tensioned to facilitate insertion between tightly spaced teeth and then wrapped around a tooth to facilitate cleaning of the front, sides, and back of each tooth above, near, or just below the gum line. The reciprocating motion is imparted to the floss whenever the floss is tensioned. The intensity of the motion is then controlled by the amount of tension and the “rigidity” of the users grip on the two handles. The drive unit handle assembly may be from an inexpensive commercially available electric toothbrush such as a Crest Spinbrush™.

U.S. Pat. No. 6,131,586, issued to Flanagan, discloses a dental floss container and dispenser having first and second sections, the first section being designed to hold a floss spool and having floss guide means to guide the floss from the floss spool to exteriorly thereof, the first section also selectively permitting and preventing the dispensing of floss from the floss spool, and the second section being designed to cut the floss and grip the floss. Preferably, both sections are ergonomically configured and sized to fit within a user's hand with each section having an ergonomic design to accept the last three fingers of the user's hand to thereby encourage use of a user's index fingers to guide the floss.

The inventions heretofore known suffer from a number of disadvantages which include being difficult to use, being difficult to control, being too slow, being non-durable, being dangerous to use, being unable to reach certain areas of the mouth, being non-portable, being uncomfortable to use, being expensive, being bulky, being inefficient, being limited in application, being limited in use, being limited in movement, not being ergonomic, being difficult for children to use, taking too long to use, blocking fingertip circulation, being difficult to travel with, being fragile, failing to significantly improve oral health, failing to reduce the incidence of tooth decay associated with less flossing during orthodontics, failing to reduce the incidence of tooth decay, failing to reduce the risk of gum disease associated with orthodontics, failing to reduce the cost associated with orthodontics, failing to reduce the incidence of white spot lesions associated with orthodontics, failing to improve the comfort and/or appearance of orthodontics, failing to reduce bad breath for those with orthodontics, failing to help maintain healthy oral habits during the orthodontic process, failing to improve the ease and/or effectiveness of orthodontics hygiene, being slow, failing to reduce the risk of soft tissue injury, failing to reduce the risk of wire/band damage due to consumer use of unconventional flossing tools, failing to decrease the time required to achieve a disease free orthodontics patient by failing to remove the step of repairing tooth/gum disease after removal of the braces, failing to decrease the time required to adjust teeth by failing to increase visibility of the teeth through reducing gingival inflammation, and being more difficult to use (especially by children and those with coordination problems), failing to increase the motivation to floss, and being cumbersome to use.

What is needed is a flossing tool that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available flossing tools. Accordingly, the present invention has been developed to provide a efficient and effective flossing tool for braces.

According to one embodiment of the invention, there is a flossing tool that may include a floss cartridge. The floss cartridge may include a length of floss and a pair of tip members each may be sized larger than a typical spacing behind arch wires of a set of braces, each may be fixedly coupled to opposite ends of the length of floss. Each tip member may include a coupling structure and a projection member opposite the coupling structure and may be coupled to the length of floss, wherein the projection member of at least one of the tip members may be elongated and sufficiently narrow to be inserted into a typical spacing behind arch wires of a set of braces. The flossing tool may include a pair of floss handles that each may be removably couple to one of the pair of tip members respectively. Each floss handle may include a cylindrical body that may be substantially larger than a typical spacing behind arch wires of a set of braces, and a release mechanism that may be disposed within the cylindrical body that may selectably couple to the associated coupling structure of the tip member and may selectably disengage from the associated coupling structure of the associated tip member when triggered. Each of the tip members may be collinear with their associated floss handles when coupled thereto.

The release mechanism may include a swivel structure that may be configured to permit the associated tip member to swivel when coupled thereto. The elongated and narrowed projection member may be arched. Both of the projection members may be elongated and sufficiently narrow to be inserted into a typical spacing behind arch wires of a set of braces. The release mechanism may be triggered by a button disposed at a bottom end of the cylindrical body. The elongated projection member may be coupled to a shoulder member having a gradually increasing size. The coupling structure may include a pair of barbed spines that may be extending opposite the projection member and the release mechanism may include an aperture in a top region of the cylindrical body that may be configured to receive the pair of barbed spines.

According to one embodiment of the invention, there is a flossing kit that may include a pair of floss handles. The flossing kit may include a plurality of floss cartridges, each may be selectably coupleable to the pair of floss handles and including a length of floss fixedly coupled to a pair of tip members, wherein at least one of the pair of tip members of each floss cartridge includes a projection member that is sized to fit behind arch wires of a set of braces. The flossing kit may include a cradle. The cradle may include a first array of recessed slots sized and shaped to receive the plurality of floss cartridges. The cradle may include a second array of recessed slots oriented substantially orthogonal to the first array of recessed slots and sized and shaped to receive the pair of floss handles, such that the pair of floss handles, when so disposed rest between tip members and above lengths of floss of floss cartridges when floss cartridges are disposed within the first array.

The flossing kit may include a cover that may be sized and shaped to envelop the cradle about all but one side. The floss handles and tip members may be shaped and sized to be too large to fit behind an arch wire of a set of braces. The projection member may be arched. The pair of floss handles each may include a release mechanism that may be configured to selectably couple to and selectably decouple from the tip floss cartridges and wherein each release mechanism includes a spring-loaded button disposed on a bottom surface of each of the floss handles, the button positioned and oriented such that it may be depressed by pressing the bottom surface of the floss handle against a surface.

The tip members may be swivel-ably coupleable to the flossing handles. The tip member may include a shoulder having a graduated size, the shoulder being coupled to the projection member. The tip members may be substantially collinear to the floss handles when coupled thereto.

According to one embodiment of the invention, there is a flossing kit that may include a plurality of floss cartridges. Each floss cartridge may include a length of floss. Each floss cartridge may include a pair of tip members each may be sized larger than a typical spacing behind arch wires of a set of braces, each may be fixedly coupled to opposite ends of the length of floss. Each tip member may include a coupling structure. Each tip member may include a projection member opposite the coupling structure and coupled to the length of floss, wherein the projection member of at least one of the tip members may be elongated and sufficiently narrow to be inserted into a typical spacing behind arch wires of a set of braces. The flossing kit may include a pair of floss handles that each may be removably coupled to one of the pair of tip members respectively. Each floss handle may include a cylindrical body that may be substantially larger than a typical spacing behind arch wires of a set of braces. Each floss handle may include a release mechanism that may be disposed within the cylindrical body that may selectably couple to the associated coupling structure of the tip member and may selectably disengage from the associated coupling structure of the associated tip member when triggered. Each of the tip members may be collinear with their associated floss handles when coupled thereto. The flossing kit may include a cradle. The cradle may include a first array of recessed slots that may be sized and shaped to receive the plurality of floss cartridges. The cradle may include a second array of recessed slots oriented substantially orthogonal to the first array of recessed slots and may be sized and shaped to receive the pair of floss handles, such that the pair of floss handles, when so disposed rest between tip members and above lengths of floss of floss cartridges when floss cartridges are disposed within the first array. The flossing kit may include a cover that may be sized and shaped to envelop the cradle about all but one side.

The elongated projection member may be arched and the release mechanism may include a swivel structure that may be configured to permit the associated tip member to swivel when coupled thereto. The release mechanism may include a spring-loaded button that may be disposed on a bottom surface of each of the floss handles, the button positioned and oriented such that it may be depressed by pressing the bottom surface of the floss handle against a surface. The coupling structure may include a pair of barbed spines that may be extending opposite the projection member and the release mechanism may include an aperture in a top region of the cylindrical body that may be configured to receive the pair of barbed spines and wherein the tip members may be substantially collinear to the floss handles when coupled thereto.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). It is noted that the drawings of the invention are not to scale. The drawings are mere schematics representations, not intended to portray specific parameters of the invention. Understanding that these drawing(s) depict only typical embodiments of the invention and are not, therefore, to be considered to be limiting its scope, the invention will be described and explained with additional specificity and detail through the use of the accompanying drawing(s), in which:

FIG. 1 is a top plan view of a flossing tool, according to one embodiment of the invention;

FIG. 2 is a top plan view of a flossing tool, according to one embodiment of the invention;

FIG. 3 is a top plan view of a projection member of a flossing tool, according to one embodiment of the invention;

FIG. 4 is a top plan view of a projection member of a flossing tool, according to one embodiment of the invention;

FIG. 5 is a top plan view of a projection member of a flossing tool, according to one embodiment of the invention;

FIG. 6 illustrates operation of a flossing tool, according to one embodiment of the invention;

FIG. 7 is a perspective view of a cradle and a housing of a flossing kit including a flossing tool, according to one embodiment of the invention;

FIG. 8 is side cross-sectional view of a pair of floss handles of a flossing kit, according to one embodiment of the invention;

FIG. 9 is a side elevational view of a pair of floss handles of a flossing kit, according to one embodiment of the invention;

FIG. 10 is a side cross-sectional view of a floss cartridge of a flossing tool, according to one embodiment of the invention;

FIG. 11 is an exploded view of a floss handle of a flossing tool, according to one embodiment of the invention; and

FIG. 12 a side cross-sectional view of a floss handle of a flossing tool, according to one embodiment of the invention.

### DETAILED DESCRIPTION OF THE INVENTION

For the purposes of promoting an understanding of the principles of the invention, reference will now be made to the exemplary embodiments illustrated in the drawing(s), and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to an “embodiment,” an “example” or similar language means that a particular feature, structure, characteristic, or combinations thereof described in connection with the embodiment is included in at least one embodiment of the present invention. Thus, appearances of the phrases an “embodiment,” an “example,” and similar language throughout this specification may, but do not necessarily, all refer to the same embodiment, to different embodiments, or to one or more of the figures. Additionally, reference to the wording “embodiment,” “example” or the like, for two or more features, elements, etc. does not mean that the features are necessarily related, dissimilar, the same, etc.

Each statement of an embodiment, or example, is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The features, functions, and the like described herein are considered to be able to be combined in whole or in part one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

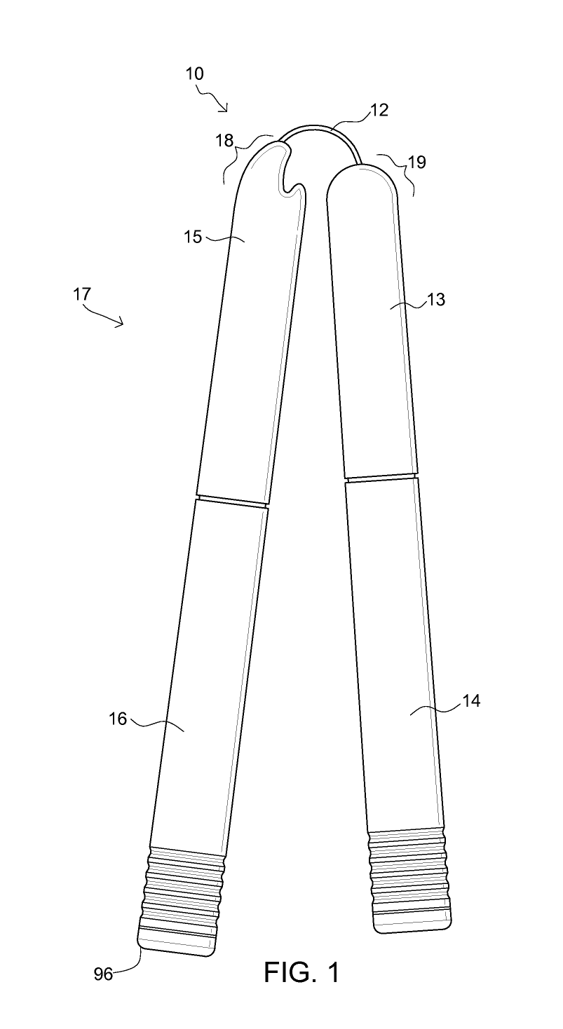

FIG. 1 is a top plan view of a flossing tool, according to one embodiment of the invention. There is shown a flossing tool 10, including a length of floss 12. The length of floss 12 may be a single thread, multi-threaded, woven thread and/or twisted fiber. Similarly, the length of floss 12 may be flat or co-axial. In addition, the length of floss 12 may include an additive. For example, the length of floss 12 may include a color, flavor, medication, or other additive appreciated in the art. For instance, the length of floss 12 may include anti-bacterial, breath-freshening, and/or other features appreciated in the art, such as, but not limited to: stainless steel; alcohol, such as but not limited to menthol, xylitol, and/or fluoride Likewise, the length of floss 12 may include colors, such as pink, blue and/or green; as well as flavoring such as peppermint, cinnamon, vanilla, or bubble gum.

Coupled to the length of floss 12 are a first floss handle 14 and a second floss handle 16. The only connection between the illustrated handles is the floss. There are no other connections, bridges, or other structures that couple the handles together. Wherein the illustrated floss cartridge (which includes the floss) is removed from the floss handles, the floss handles are no longer coupled together.

The first floss handle 14 and the second floss handle 16 may be selectably coupleable to the length of floss 12. Additionally, the first floss handle 14 and/or the second floss handle 16 may vibrate and/or may be ultrasonic. Further the handles 14, 16 may include any shape and/or design such as, but not limited to: angled, elbowed, curved, straight and/or rounded. Moreover, the handles 14, 16 may include a material for gripping and/or may be rigid or flexible. Accordingly, the handles 14, 16 may be constructed of any material appreciated in the art, such as, but not limited to: plastic, rubber, Teflon, metal, silicone, or other composite material.

Also illustrated in FIG. 1 is a projection member, or projection portion, 18. The projection member 18 extends from the second floss handle 16 and terminates in the length of floss 12. The projection member 18 may be constructed from the same material as the second floss handle 16 and may be an extension thereof. As shown, the projection member 18, may have any shape appreciated in the art, such as, but not limited to: L-shaped, C-shaped, U-shaped, S-shaped, rod-shaped, I-shaped, and/or any shape that is narrowing, peaked, sharp, rounded, rigid, or pointed. Likewise, the projection member 18 may be curved, straight, long, short, angled, extending straight, and/or have an oval, round, or other cross-section. Accordingly, the projection member 18 may include a shoulder or stop which may brace the projection member 18 and/or prevent a user from inadequately or inappropriately using the tool 10.

Furthermore, the projection member 18, may be constructed of any material appreciated in the art, such as, but not limited to: plastic, rubber, Teflon, metal, silicone, or other composite material. As a result, the projection member 18 may be more or less flexible than the second floss handle 16. The projection member 18 and/or floss handle 16 may also have any color appreciated in the art, such as, but not limited to: white, blue, green, yellow, red, black, purple, and/or orange.

Also shown, the first floss 14 handle includes an end member, or end portion, 19 terminating in the length of floss 12. Advantageously, the first floss handle 14 may be shaped for safe disposal within a mouth. Accordingly, the first floss handle 14 may have an end member 19 which is flat, rounded, curved, straight, smooth, short, long, and/or have and oval, round, or other cross-section.

Therefore, the end member 19 may have an identical, similar, or different appearance than that of the projection member 18. Similarly, the end member 19 may composed of a material similar to, or different from that of the projection member 18, such as, but not limited to: plastic, rubber, Teflon, metal, silicone, or other composite material. Too, the end member 19 and/or floss handle 14 may also have any color appreciated in the art, such as, but not limited to: white, blue, green, yellow, red, black, purple, and/or orange. As a result, the members 18, 19 may be free to rotate or deviate from an axis of the handles 14, 16. Conversely, the members 18, 19 may be fixed to the handles 14, 16 and may not be free to rotate about an axis of the handles 14, 16.

In one non-limiting embodiment, there is a tip configured for use with the handle-based flossing tool that allows the user to floss around the bands and brackets and underneath the wire while in orthodontics. The tip is generally L-shaped or otherwise narrowed with the top region of the L having the floss extending therefrom. The tip has been narrowed in a manner that permits the user to fit the tip in that smaller space. Such a tool allows people with a full set of braces to floss their teeth with ease and speed. This is possible because the tip can go between the orthodontic arch wire of the braces and the teeth and allows them to floss. The tip is coupled to a pair of handles.

In another non-limiting embodiment, there is a flossing tool including a pair of handles coupled by a length of floss. The tip of one of the handles is shaped to include a projection terminating in the floss, wherein the projection is shaped to extend into and fit into the space between a user's teeth and the arch wire between the brackets and bands, while the other tip is shaped to be safely placed inside the mouth. Floss may extend from the edge of the projection and/or from an end region of the projection and may extend directly outwardly from the same and/or extend at an angle relative to the long axis of the handles and/or the long axis of the projection. The projection may be aligned with the long axis of the handle or may deviate therefrom. The projection may extend from a central region of an end portion of a handle and/or may extend from a radial region of an end portion of a handle.

Advantageously, the flossing tool 10 permits users to form a C-shaped configuration during flossing, which permits enhanced removal of materials between teeth. Devices and systems having inflexible or fixed position braces for the floss lengths do not permit this. Additionally advantageous, the projection member 18 is enables a user with orthodontics to floss previously hard to reach areas, such as underneath wires and between brackets.

According to one embodiment of the invention, there is a flossing tool 10 that includes a floss cartridge 17. The floss cartridge 17 includes a length of floss 12 and a pair of tip members 13, 15 each sized larger than a typical spacing behind arch wires of a set of braces, each fixedly coupled to opposite ends of the length of floss 12. Each tip member 13, 15 includes a coupling structure 19 and a projection member 18 opposite the coupling structure 19 and is coupled to the length of floss 12, wherein the projection member 18 of at least one of the tip members 15 is elongated and sufficiently narrow to be inserted into a typical spacing behind arch wires of a set of braces. The flossing tool 10 includes a pair of floss handles 14, 16 that each are removably coupleable to one of the pair of tip members 13, 15 respectively. Each floss handle 14, 16 includes a cylindrical body that is substantially larger than a typical spacing behind arch wires of a set of braces, and a release mechanism 96 that is disposed within the cylindrical body that may selectably couple to the associated coupling structure of the tip member and may selectably disengage from the associated coupling structure of the associated tip member when triggered. Each of the tip members 13, 15 are collinear with their associated floss handles when coupled thereto.

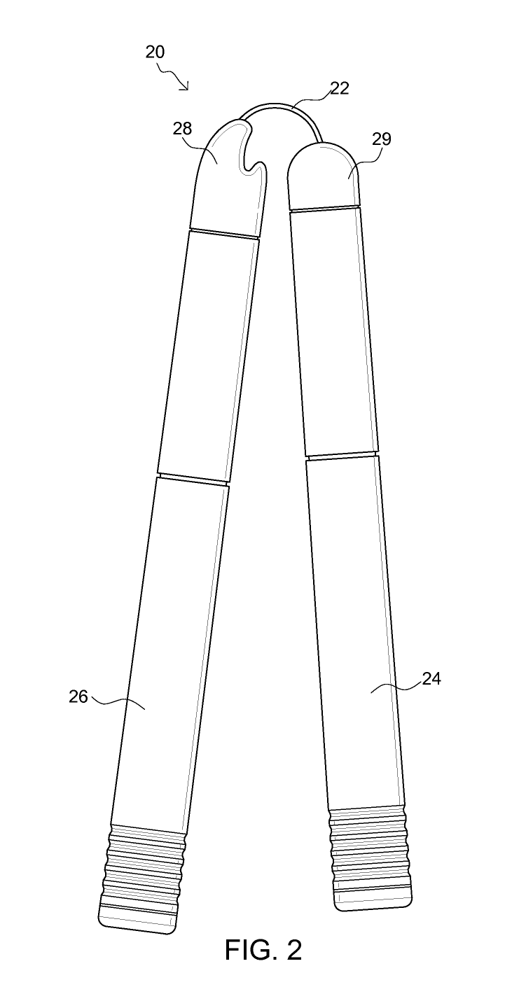

FIG. 2 is a top plan view of a flossing tool, according to one embodiment of the invention. There is shown a flossing tool 20, including a length of floss 22. The length of floss 22 may be a single thread, multi-threaded, woven thread and/or twisted fiber. Similarly, the length of floss 22 may be flat or co-axial. In addition, the length of floss 22 may include an additive. For example, the length of floss 22 may include a color, flavor, medication, or other additive appreciated in the art. For instance, the length of floss 22 may include anti-bacterial, breath-freshening, and/or other features appreciated in the art, such as, but not limited to: stainless steel; alcohol, such as menthol or xylitol, and/or fluoride. Likewise, the length of floss 22 may include colors, such as pink, blue and/or green; as well as flavoring such as peppermint, cinnamon, vanilla, or bubble gum.

Coupled to the length of floss 22 is a first floss handle 24 and a second floss handle 26. The first floss handle 24 and the second floss handle 26 may be selectably coupleable to the length of floss 22. Additionally, the first floss handle 24 and/or the second floss handle 26 may vibrate and/or may be ultrasonic. Further the handles 24, 26 may include any shape and/or design such as, but not limited to: angled, elbowed, curved, straight and/or rounded. Moreover, the handles 24, 26 may include a material for gripping and/or may be rigid or flexible. Accordingly, the handles 24, 26 may be constructed of any material appreciated in the art, such as, but not limited to: plastic, rubber, Teflon, metal, silicone, or other composite material.

FIG. 2 also illustrates a projection member 28. The projection member 28 extends from the second floss handle 26 and terminates in the length of floss 22. The projection member 28 may be constructed from a material different from the second floss handle 26, or may be an extension thereof. Additionally, the projection member 28 may have and appearance different from that of the second floss handle 26, such as, but not limited to different color and/or shape.

As shown, the projection member 28 may have any shape appreciated in the art, such as, but not limited to: L-shaped, C-shaped, U-shaped, S-shaped, rod-shaped, I-shaped, and/or any shape that is narrowing, peaked, sharp, rounded, rigid, or pointed. Likewise, the projection member 28 may be curved, straight, long, short, angled, extending straight, and/or have an oval, round, or other cross-section. Accordingly, the projection member 28 may include a shoulder or stop which may brace the projection member 28 and/or prevent a user from inadequately or inappropriately using the system 20.

Furthermore, the projection member 28 may be constructed of any material appreciated in the art, such as, but not limited to: plastic, rubber, Teflon, metal, silicone, or other composite material. As a result, the projection member 28 may be more or less flexible than the second floss handle 26. The projection member 28 and/or floss handle 26 may also have any color appreciated in the art, such as, but not limited to: white, blue, green, yellow, red, black, purple, and/or orange.

Also shown, the first floss 24 handle includes an end member 29 terminating in the length of floss 22. Advantageously, the first floss handle 24 may be shaped for safe disposal within a mouth. Accordingly, the first floss handle 24 may have an end member 29 which is flat, rounded, curved, straight, smooth, short, long, and/or have and oval, round, or other cross-section.

Therefore, the end member 29 may have an identical, similar, or different appearance than that of the projection member 28. Similarly, the end member 29 may include a material similar to, or different from that of the projection member 28, such as, but not limited to: plastic, rubber, Teflon, metal, silicone, or other composite material. Too, the end member 29 and/or floss handle 24 may also have any color appreciated in the art, such as, but not limited to: white, blue, green, yellow, red, black, purple, and/or orange. As a result, the members 28, 29 may be free to rotate or deviate from an axis of the handles 24, 26. Conversely, the members 28, 29 may be fixed to the handles 24, 26 and may not be free to rotate about an axis of the handles 24, 26.

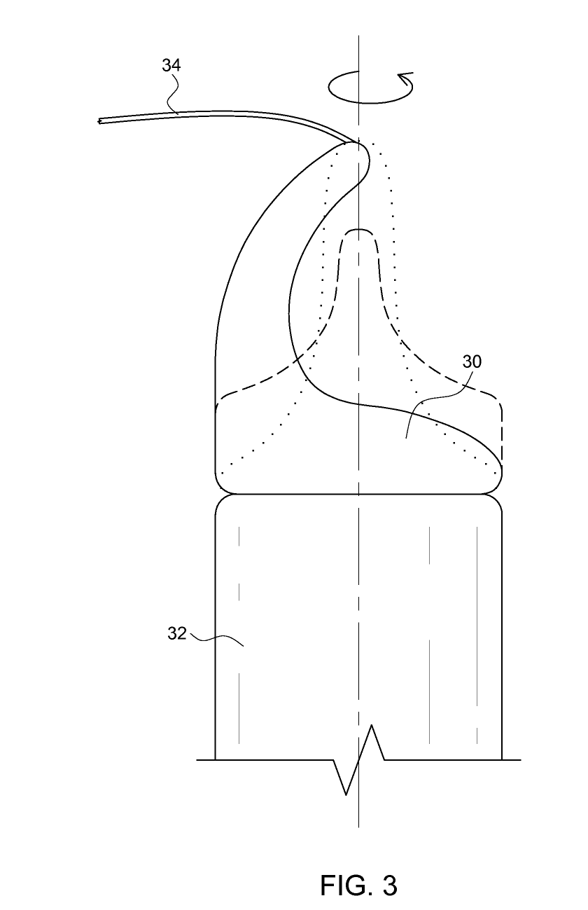

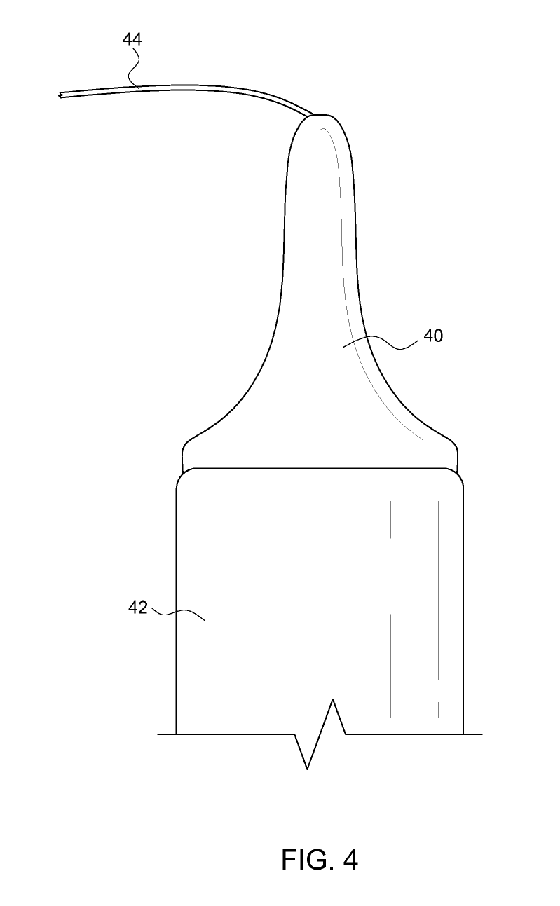

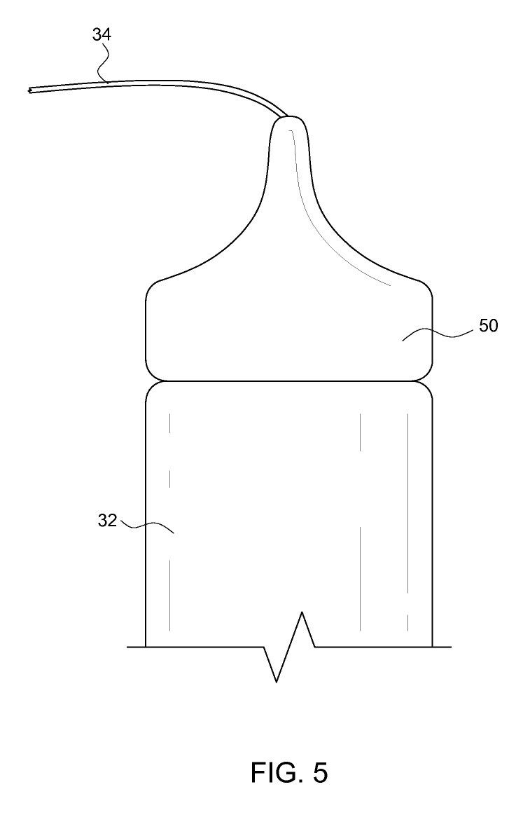

FIG. 3 is a top plan view of a projection member of a flossing tool, according to one embodiment of the invention. Shown is a projection member 30, coupled to a floss handle 32 and extending outwardly therefrom, terminating in a length of floss. 34. The projection member 30 may be selectably coupleable to the floss handle 32. Dotted outlines illustrate non-limiting alternative shapes for projection members that match with those illustrated in FIGS. 4 and 5.

The illustrated projection member 30, includes a short wide base that narrows towards the top into a finger that is shaped and sized to be able to fit between arch wires of braces. The finger is off-center to the base and curved inwardly with regard to a primary axis of rotation of the projection member 30 and the handle 32. The illustrated projection member 30 is rotatably coupled to the handle 32, such that it may rotate as illustrated by the arrow about the illustrated axis of rotation. The finger may be of a flexible/elastic material sufficiently so such that it may deform elastically under normal operating conditions, thereby making it easier for the user to insert and use it, while still maintaining its advantageous shape from flossing action to flossing action as the user progressively flosses between various adjacent teeth.

FIG. 4 is a top plan view of a projection member of a flossing tool, according to one embodiment of the invention. There is illustrated a projection member 40, coupled to a floss handle 42 and extending outwardly therefrom, terminating in a length of floss 44. The projection member 40 may be selectably coupleable to the floss handle 42.

The illustrated projection member 40 includes a tapering region that terminates in a short wide base, with nearly all of the height of the projection member being of sufficient size and shape to fit between arch wires of braces. It may be that the projection member 40 is of a flexible material, such as but not limited to rubber and/or plastic, such that it may bend under stress, thus making it easier to fit between substantially rigid arch wires, even if not inserted at a perfectly aligned angle of entry.

FIG. 5 is a top plan view of a projection member of a flossing tool, according to one embodiment of the invention. As illustrated, a projection member 50 is coupled to a floss handle 32 and extends outwardly therefrom, terminating in a length of floss 34. The projection member 50 may be selectably coupleable to the floss handle 32. The illustrated projection member 50 includes an upper portion that is elongated and narrowed so as to be able to fit between arch wires of braces, while its base is not. The illustrated elongated portion of the illustrated projection member 50 extends from a central region of the projection member and is aligned with a main axis of rotation of the handle. The base of the projection member 50 is taller and more substantial than that illustrated in FIG. 4. It may be that the elongated region of the projection member 50 comprises a material that is flexible and/or elastically deformable and perhaps even to a degree greater than the base of the projection member, either in material itself or merely because it is thinner but still of the same material.

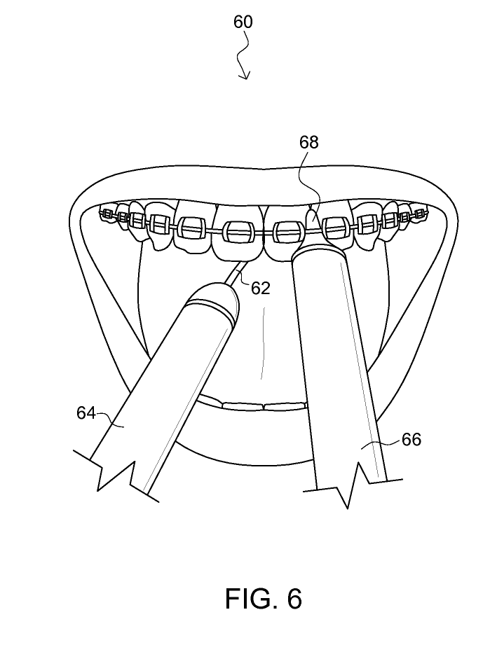

FIG. 6 illustrates operation of a flossing tool, according to one embodiment of the invention. There is illustrated a flossing tool 60, including a length of floss 62.

Coupled to the length of floss are a first floss handle 64 and second floss handle 66. There is also shown a projection member 68 extending from the second floss handle 66 and terminating in a length of floss 62. The illustrated projection member 68 is between illustrated arch wires of braces.

In operation of one embodiment of the flossing tool 60, a user grasps the first floss handle 64 and the second floss handle 66. The user then inserts the projection member 68 of the second floss handle 66 under a wire and between brackets of orthodontics of a mouth. Next, the user inserts the first floss handle 64 into the mouth thereby pulling the length of floss 62 between teeth and to the gums, and flosses by moving the first floss handle 64 up and down, side-to-side, and/or in a circular motion.

Advantageously, the projection member 68 enables a user to floss around the bands and brackets, as well as underneath wires, of orthodontics. Similarly, the projection member may permit a user to floss in other areas of the mouth which may be smaller and/or be difficult to reach due to the presence of other dental devices, such as permanent retainers. Contrastingly, first floss handle 64 may include a rounded, cushioning, and/or smooth surface for comfortable and/or safe insertion into the mouth.

Accordingly, the flossing tool 60 may improve oral health of a user by: reducing the incidence of tooth decay associated with less flossing during orthodontics and other dental impediments; reducing the risk of gum disease associated with orthodontics and other dental impediments; reducing the incidence of white spot lesions associated with orthodontics; reducing bad breath; helping to maintain healthy oral habits; making it faster, easier, and more effective for a user to floss; reducing the risk of soft tissue damage and/or injury; reducing the risk of damage to orthodontics; increasing visibility of the teeth for cleaning and repair; increasing motivation and/or attractiveness of flossing; and increasing the user's ability to grasp and manipulate the handles. As a result, the flossing tool 60 may reduce the total cost associated with orthodontics and good dental hygiene. In addition, the flossing tool 60 may improve the overall comfort and appearance of orthodontics.

In addition to improving oral health by flossing small and/or hard to reach areas of the mouth, the flossing tool 60 may include anti-bacterial, breath-freshening, and/or other features appreciated in the art, such as, but not limited to: stainless steel; alcohol, such as menthol or xylitol, and/or fluoride. Likewise, the flossing tool 60 may include colors and flavoring such as peppermint, cinnamon, vanilla, or bubble gum, thereby further adding to its attractiveness to children and youth.

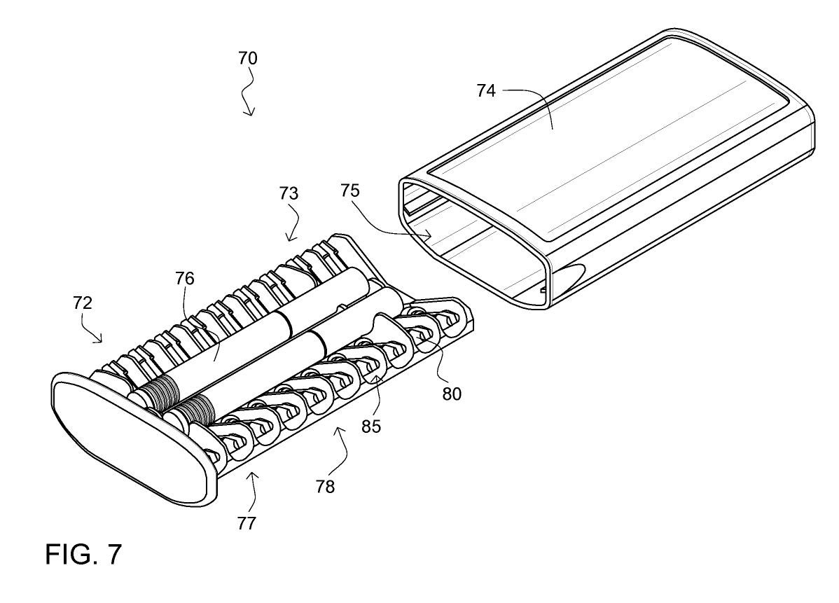

FIG. 7 is a perspective view of a cradle and a housing of a flossing kit including a flossing tool, according to one embodiment of the invention. There is shown a flossing tool 70 including a pair of floss handles 76 and a plurality of floss cartridges 78 disposed within a cradle 72 that may be disposed within a housing 74.

The illustrated floss system 70 includes a housing 74 configured to receive the cradle 72 and cover a top portion thereof. The illustrated housing 74 includes an aperture 75 configured to be sized and shaped to receive a back profile of the cradle 72 and secure the cradle 72 therein. The housing 74 provides covering and protection to the cradle and the contents thereof from dust, fluids, disturbance and other undesired interaction during travel and other times when the system is not actively being used. A housing may include one or more flat or curved surfaces that may be coupled to one or more coupling members/devices such as but not limited to ridges, hook and loop portions, tongue and groove members, clips, hooks, and the like and combinations thereof. A housing may be fluid/water/air/etc. tight and/or may include one or more decorative elements thereon including but not limited to logos, graphics, mirrors, textured surfaces, and the like and combinations thereof.

The illustrated flossing tool 70 includes a cradle 72. The illustrated cradle 72 includes a pair of channels configured to receive and support a pair of floss handles 76 thereon. The pair of channels are disposed longitudinally along a central region of the cradle 72. The pair of channels include a profile configured to be sized and shaped to receive a pair of floss handles 76. The flossing tool 70 includes a pair of floss handles 76 disposed on the cradle 72. The cradle 74 also includes a plurality of dividers generating an array of receptacles for holding the floss cartridges 78. The illustrated dividers are shaped and positioned to form the pair of channels and the receptacles that nest the floss cartridges 78 and the floss handles 76. Two sets of the illustrated dividers are shaped with an extended upper region to help secure the floss handles in the channels more tightly. Channels and receptacles may be formed through a variety of structures, including but not limited to quilted flexible materials, channeled plastic/elastic materials, arrays of coupling members/materials such as but not limited to magnets, hook and loop, straps, clips, tongue and groove, and the like and combinations thereof.

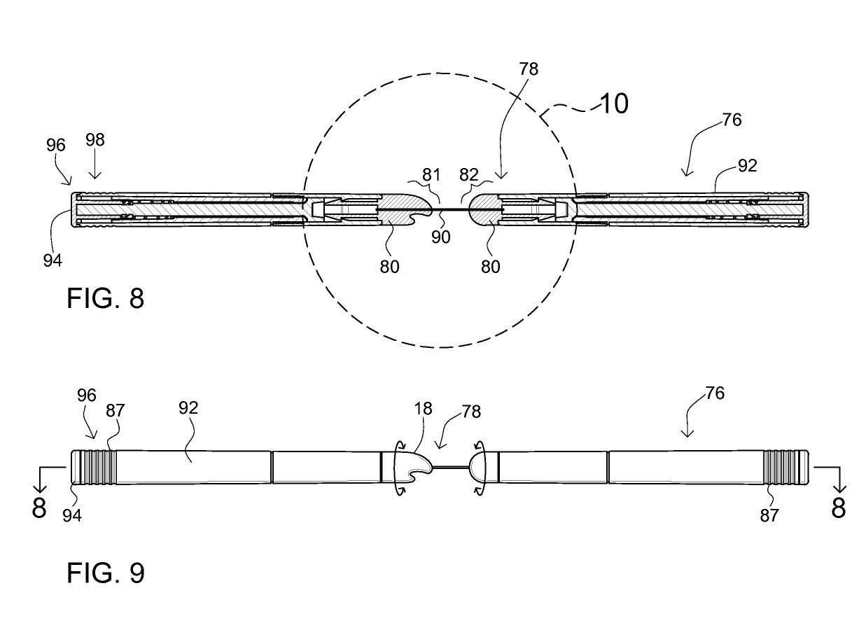

The illustrated array of floss cartridges 78 is disposed within the cradle 72 in an array along the length of the cradle 72. The coupling members 80 of the cartridges 78 are disposed on each side of the cradle 74 and the floss itself (See FIG. 8) lies between paired coupling members 80. The array of floss cartridges 78 include a coupling member 80 configured to selectably couple to a floss handle 76. The illustrated coupling members 80 are configured to be extending outwardly from a central region of the cradle 72. Advantageously, the floss cartridges 78 are available for use and coupling to the floss handles 76 when the floss handles are removed from the cradle 72. Where floss cartridges are used to a point where they should be discarded, the cartridge may be discarded and another conveniently coupled to the floss handles. Accordingly, the floss handles may be reused.

The illustrated pair of floss handles 76 are sized and shaped to nest within the cradle and include one or more coupling members/devices configured to selectably coupleable to a coupling member 80 of a floss cartridge 78. The floss handles 76 include one or more devices for selectably coupling/decoupling the floss cartridges thereto, such as but not limited to connectors (such as but not limited to hooks, snaps, friction engagement, latches, pins, and the like and combinations thereof), disconnectors (such as but not limited to movable engagement devices, levers, devices that change the effective size of an object, and the like and combinations thereof), and activation members (buttons, switches, spring operated activators, and the like and combinations thereof) and the like and combinations thereof.

The floss handles are shaped and sized to permit a user to manipulate the same with their hands such that a floss filament associated with a floss cartridge may be disposed within the mouth and placed between adjacent teeth such that material may be removed therefrom for the health of the user. Advantageously, the floss handles provide leverage and extension of the users own hands thereby effectively strengthening the user in relation to the task to be performed and facilitating the dexterous use thereof. This is particularly helpful when children are using the devices as children generally lack the strength and dexterity of adults and therefore may more easily misuse or be frustrated by flossing tools designed and optimized for adults. Further, because the floss handles do not limit arcuate positioning of the floss filament, the floss may be positioned in a C-style formation about the teeth when in use. Such a formation is known to be very effective at leaning the space between adjacent teeth.

In operation a user may take a system to a location with the members coupled together within the housing. The user may withdraw the cradle from the housing and withdraw the floss handles from the cradle. The user may engage a floss cartridge with the floss handles by selectably coupling the floss cartridge therebetween. Then the user may engage in the process of flossing. Where desired, the user may push a release button or otherwise actively disengage the floss cartridge from the floss handles and may discard the floss cartridge or return it to the cradle.

According to one embodiment of the invention, there is a flossing kit 70 including a pair of floss handles 76. The flossing kit 70 includes a plurality of floss cartridges 78, each selectably coupleable to the pair of floss handles 76 and including a length of floss fixedly coupled to a pair of tip members, wherein at least one of the pair of tip members of each floss cartridge includes a projection member that is sized to fit behind arch wires of a set of braces. The flossing kit 70 includes a cradle 72. The cradle 72 includes a first array of recessed slots 73 sized and shaped to receive the plurality of floss cartridges 78. The cradle 72 includes a second array of recessed slots 77 oriented substantially orthogonal to the first array of recessed slots 73 and sized and shaped to receive the pair of floss handles 76, such that the pair of floss handles 76, when so disposed rest between tip members and above lengths of floss of floss cartridges when floss cartridges are disposed within the first array 73. The flossing kit 70 includes a cover 74 sized and shaped to envelop the cradle 72 about all but one side. The floss handles 76 and tip members are shaped and sized to be too large to fit behind an arch wire of a set of braces.

According to one embodiment of the invention, there is a flossing kit 70 that includes a plurality of floss cartridges 78. Each floss cartridge 78 includes a length of floss. Each floss cartridge 78 includes a pair of tip members each sized larger than a typical spacing behind arch wires of a set of braces, each are fixedly coupled to opposite ends of the length of floss. Each tip member includes a coupling structure 80. The coupling structure 80 includes a pair of barbed spines 85 that are extending opposite the projection member and the release mechanism includes an aperture in a top region of the cylindrical body that may be configured to receive the pair of barbed spines 85.

Each tip member includes a projection member opposite the coupling structure and coupled to the length of floss, wherein the projection member of at least one of the tip members may be elongated and sufficiently narrow to be inserted into a typical spacing behind arch wires of a set of braces. The flossing kit 70 includes a pair of floss handles 76 that each are removably coupled to one of the pair of tip members respectively. Each floss handle 76 includes a cylindrical body that is substantially larger than a typical spacing behind arch wires of a set of braces. Each floss handle 76 include a release mechanism that may be disposed within the cylindrical body that may selectably couple to the associated coupling structure of the tip member and may selectably disengage from the associated coupling structure of the associated tip member when triggered. Each of the tip members are collinear with their associated floss handles when coupled thereto. The flossing kit 70 includes a cradle 72. The cradle 72 includes a first array of recessed slots 73 that are sized and shaped to receive the plurality of floss cartridges 78. The cradle 72 includes a second array of recessed slots 77 oriented substantially orthogonal to the first array of recessed slots 73 and sized and shaped to receive the pair of floss handles 76, such that the pair of floss handles 76, when so disposed rest between tip members and above lengths of floss of floss cartridges when floss cartridges are disposed within the first array 73. The flossing kit 70 includes a cover 74 sized and shaped to envelop the cradle 72 about all but one side.

FIG. 8 is side cross-sectional view of a pair of floss handles of a flossing kit, according to one embodiment of the invention. There is shown a pair of floss handles 76 coupled to a floss cartridge 78 and thereby coupled to each other through the floss filament of the floss cartridge. Accordingly, the floss handles together with the floss cartridge generate a unitary flossing tool that a user may manipulate with hands to clean spaces between teeth.

The illustrated flossing tool includes a pair of floss handles 76 selectably coupleable to a floss cartridge 78. The floss cartridge 78 includes a pair of coupling members 80 coupled together by a length of floss, or floss filament, 90. The pair of coupling members 80 are each coupled to opposite ends of the length of floss 90. Such coupling may be by any of various methods including but not limited to friction fitting, welding, knotted (or otherwise oversized) floss ends, and the like and combinations thereof. Floss may extend through one or more apertures through coupling members. Each floss cartridge 78 includes a coupling structure configured to selectably couple to a floss handle 76. The illustrated coupling structure includes biased extensions, or prongs, having hook-shaped heads that engage an appropriately shaped protrusion when inserted into a cavity having such a protrusion. Advantageously, when the illustrated coupling structure engages, the coupling structure snaps into place and may naturally generate a tactile and/or audible signal that cues the user to know that the coupling structure is snugly in place and ready to use.

As illustrated, the coupling members 80 include a projection portion 81 and an end portion 82, respectively. The projection portion 81 may be constructed from the same material as the coupling members 80, and may be an extension thereof or may include one or more different materials and/or may be selectably coupled thereto. The projection portion 81, may have any shape appreciated in the art, such as, but not limited to: L-shaped, C-shaped, U-shaped, S-shaped, rod-shaped, I-shaped, and/or any shape that is narrowing, peaked, sharp, rounded, rigid, or pointed. Likewise, the projection portion 81, may be curved, straight, long, short, angled, extending straight, and/or have an oval, round, or other cross-section. Accordingly, the projection portion 81 may include a shoulder or stop which may brace the projection portion 81 and/or prevent a user from inadequately or inappropriately using the system 70.

Furthermore, the projection portion 81, may be constructed of any material appreciated in the art, such as, but not limited to: plastic, rubber, Teflon, metal, silicone, or other composite material. As a result, the projection portion 81 may be more or less flexible than the floss handle 76. The projection portion 81 and/or floss handle 76 may also have any color appreciated in the art, such as, but not limited to: white, blue, green, yellow, red, black, purple, and/or orange.

The illustrated end portion 82, may be shaped for safe disposal within a mouth. Accordingly, the coupling members 80, may have and end portion which is flat, rounded, curved, straight, smooth, short, long, and/or have and oval, round, or other cross-section. Therefore, the end portion 82 may have an identical, similar, or different appearance than that of the projection portion 81. Similarly, the end portion 82 may composed of a material similar to, or different from that of the projection portion 81, such as, but not limited to: plastic, rubber, Teflon, metal, silicone, or other composite material. Also, the end portion 82 may be any color appreciated in the art, such as, but not limited to: white, blue, green, yellow, red, black, purple, and/or orange. As a result, the portions 81, 82 may be free to rotate or deviate from an axis of the handle 76. Conversely, the portions 81, 82 may be fixed to the handle 76 and may not be free to rotate about an axis of the handle 76.

The illustrated pair of floss handles 76 includes a cylindrical body 92 having an inner neck portion that forms a narrowed region and an expanded region that permits engagement of the hook-shaped heads thereon. The pair of floss handles 76 include a release mechanism 96 disposed within the cylindrical body 92 and configured to selectably disengage the floss handle 76 from the coupling member 80. The illustrated release mechanism 96 includes an actuation member, or button, 94 disposed through a flexible back end portion 98 of the cylindrical body 92 of each of the pair of floss handles 76. The illustrated back end portion 98 includes an accordion-style material of flexible or partially flexible material such that its effective size may be changed under force while protecting a user from pinching or other undesired effects of having ones hands near two objects that are movable relative to each other. The button 94 is functionally coupled to a bias member (spring) that is positioned and engaged with an interior of the body of the floss handle such that the spring pushes against the button and resists the depression thereof. When the button is pressed, a cup shaped member functionally coupled to the button engages with ends of the coupling member in a manner that disengages the coupling member from the floss handles so that the coupling member may be withdrawn and decoupled from the floss handle.

FIG. 9 is a side elevational view of a pair of floss handles of a flossing kit, according to one embodiment of the invention. There is shown a pair of floss handles 76 coupled together by a floss cartridge 78.

The illustrated pair of floss handles 76 are coupled together by a floss cartridge 78. The floss cartridge 78 includes a pair of coupling members attached by a length of floss and configured to selectably couple to a pair of floss handles 76. The illustrated pair of floss handles 76 each include a cylindrical body 92. The pair of floss handles 76 includes a release mechanism 96 disposed within the cylindrical body 92 and configured to selectably disengage the floss handle 76 from a coupling member of the floss cartridge 78. The release mechanism 96 includes an actuation member 94 disposed through a back end of the cylindrical body 92 of each of the pair of floss handles 76.

According to one embodiment of the invention, there is a release mechanism 96 including a swivel structure 87 configured to permit the associated tip member to swivel when coupled thereto. The elongated and narrowed projection member 18 is arched. Both of the projection members 18 are elongated and sufficiently narrow to be inserted into a typical spacing behind arch wires of a set of braces. The release mechanism 96 is triggered by a button 94 disposed at a bottom end of the cylindrical body 92. The elongated projection member 18 is coupled to a shoulder member having a gradually increasing size.

According to one embodiment of the invention, there is a projection member may be arched. The pair of floss handles each may include a release mechanism that may be configured to selectably couple to and selectably decouple from the tip floss cartridges and wherein each release mechanism includes a spring-loaded button disposed on a bottom surface of each of the floss handles, the button positioned and oriented such that it may be depressed by pressing the bottom surface of the floss handle against a surface.

The tip members may be swivel-ably coupleable to the flossing handles. The tip member may include a shoulder having a graduated size, the shoulder being coupled to the projection member. The tip members may be substantially collinear to the floss handles when coupled thereto.

The elongated projection member may be arched and the release mechanism may include a swivel structure that may be configured to permit the associated tip member to swivel when coupled thereto. The release mechanism may include a spring-loaded button that may be disposed on a bottom surface of each of the floss handles, the button positioned and oriented such that it may be depressed by pressing the bottom surface of the floss handle against a surface. The coupling structure may include a pair of barbed spines that may be extending opposite the projection member and the release mechanism may include an aperture in a top region of the cylindrical body that may be configured to receive the pair of barbed spines and wherein the tip members may be substantially collinear to the floss handles when coupled thereto.

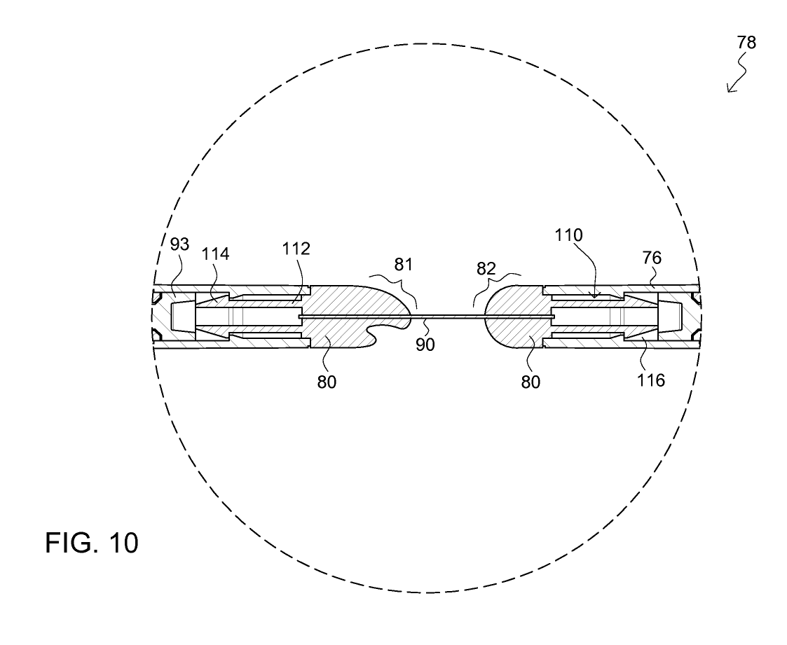

FIG. 10 is a side cross-sectional view of a floss cartridge of a flossing tool, according to one embodiment of the invention. There is shown a floss cartridge 78 including a pair of engaged coupling members 80 and a length of floss 90.

The illustrated floss cartridge 78 includes a length of floss 90. The floss cartridge 78 includes a pair of coupling members 80, having a respective projection portion 81 and an end portion 82, each coupled to opposite ends of the length of floss 90. Each floss cartridge 78 includes a coupling structure 110. The coupling structure 110 of the pair of coupling members 80 each includes an attachment member 112 having an attachment end 114 configured to retractably fit inside a top aperture of a floss handle 76. The pair of floss handles 76 each include a receiving member 116 configured to securely attach to the attachment end 114 of the attachment member 112. The receiving member 116 is coupled to a release mechanism of the floss handle 76 that is configured to release the attachment end 114 from the receiving member 116. The attachment end 114 is adjacent a detachment member 93 that includes a cup-shaped end configured to engage the attachment member in a manner that causes the attachment member to disengage with the floss handle when the detachment member is moved relative to the attachment end. In the illustrated example, the detachment member 93 is moved towards the attachment end thereby engaging with the ramp-shaped end of the attachment end and causing the same to be displaced towards the main axis of the floss handle. This motion disengages the hook-shaped portion of the attachment end from the interior surface of the floss handle and thereby permits the user to detach the same from the floss handle.

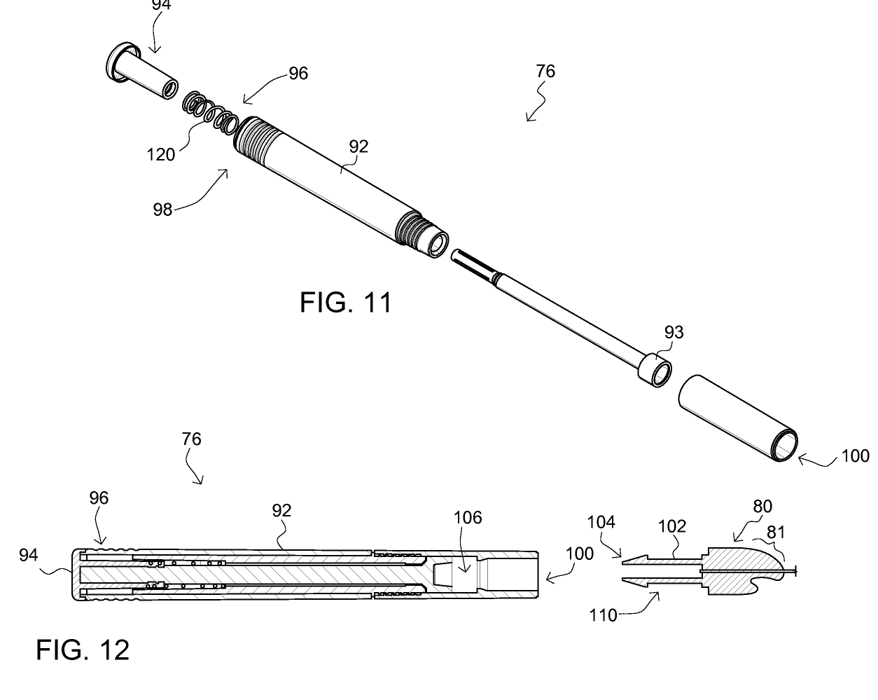

FIG. 11 is an exploded view of a floss handle of a flossing tool, according to one embodiment of the invention. There is shown a floss handle 76 including a cylindrical body 92, and a release mechanism 96.

The illustrated floss handle 76 includes a cylindrical body 92. The cylindrical body 92 is configured to support and protect the components of the floss handle. The cylindrical body 92 is configured to provide a rigid structure to manipulate and maneuver a length of floss between teeth. The floss handle 76 includes a release mechanism 96 disposed within the cylindrical body 92 and configured to selectably disengage the floss handle 76 from a coupling member of a floss cartridge. The release mechanism 96 includes a biased member 120 configured to compression release a coupling member from the floss handle 76. The release mechanism 96 includes an actuation member 94 disposed through a back end 98 of the cylindrical body 92 of the floss handle 76. The floss handle 76 includes a top aperture 100 configured to receive a coupling structure of a coupling member of a floss cartridge of a flossing tool. The floss handle 76 includes a detachment member 93 that includes a cup-shaped end configured to engage an attachment member in a manner that causes the attachment member to disengage with the floss handle 76 when the detachment member 93 is moved relative to the attachment end.

FIG. 12 a side cross-sectional view of a floss handle of a flossing tool, according to one embodiment of the invention. There is shown a floss handle 76 including a cylindrical body 92, a release mechanism 96, and a receiving member 106. The illustrated floss handle 76 includes a cylindrical body 92. The floss handle 76 includes a release mechanism 96 disposed within the cylindrical body and be configured to selectably disengage the floss handle 76 from a coupling member 80, including a projection portion 81, of a floss cartridge, the projection portion shaped and sized to fit behind/between arch wires of braces on teeth. The release mechanism 96 includes an actuation member 94 disposed through a back end of the cylindrical body 92 of the floss handle 76. The floss handle 76 includes a top aperture 100 configured to receive a coupling structure 110 of the coupling member 80. The coupling structure 110 of the coupling member 80 includes an attachment member 102 configured to couple to the floss handle 76. The attachment member 102 includes an attachment end 104 configured to retractably fit inside the top aperture 100 of the floss handle 76. The illustrated attachment member 102 includes a pair of opposing flanges configured to compress toward one another and couple to a receiving member 106 of the floss handle. The attachment end 104 includes an angled protrusion disposed on an end of a flange and configured to secure the attachment member 102 to the floss handle. The receiving member 106 is configured to securely attach to the attachment end 104 of the attachment member 102. The receiving member 106 is coupled to the release mechanism 94 of the floss handle 76 and configured to release the attachment end 104 from the receiving member 106. The receiving member 106 includes a cavity larger than the cavity of the top aperture of the floss handle, thereby securing the angled protrusions of the attachment member therein.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

For example, although the figures illustrate projection members that are contiguous with their attached structures, there may be projection members that are less integral to the surrounding structure, such as but not limited to those coupled by hinges (including but not limited to living hinges of an elastically deformable material, such as but not limited to plastic).

It is expected that there could be numerous variations of the design of this invention. An example is that the floss handles may taper, curve and/or otherwise be shaped differently than that illustrated.

Finally, it is envisioned that the components of the device may be constructed of a variety of materials, including but not limited to ceramics, plastics, metals, rubbers, composites and the like and combinations thereof.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims. Further, it is contemplated that an embodiment may be limited to consist of or to consist essentially of one or more of the features, functions, structures, methods described herein.

What is claimed is:

1. A flossing tool, comprising
a) a floss cartridge, including:
a length of floss; and
a pair of tip members each sized larger than a typical spacing behind arch wires of a set of braces, each fixedly coupled to opposite ends of the length of floss and each including:
a coupling structure; and
a projection member opposite the coupling structure and coupled to the length of floss, wherein the projection member of at least one of the tip members is elongated and sufficiently narrow to be inserted into a typical spacing behind arch wires of a set of braces; and
b) a pair of floss handles that each removably couple to one of the pair of tip members respectively, each floss handle including:
a cylindrical body substantially larger than a typical spacing behind arch wires of a set of braces, and
a release mechanism disposed within the cylindrical body that selectably couples to the associated coupling structure of the tip member and selectably disengages from the associated coupling structure of the associated tip member when triggered; and wherein each of the tip members are collinear with their associated floss handles when coupled thereto.

2. The flossing tool of claim 1, wherein the release mechanism includes a swivel structure configured to permit the associated tip member to swivel when coupled thereto.

3. The flossing tool of claim 1, wherein the elongated and narrowed projection member is arched.

4. The flossing tool of claim 1, wherein both of the projection members are elongated and sufficiently narrow to be inserted into a typical spacing behind arch wires of a set of braces.

5. The flossing tool of claim 1, wherein the release mechanism is triggered by a button disposed at a bottom end of the cylindrical body.

6. The flossing tool of claim 1, wherein the elongated projection member is coupled to a shoulder member having a gradually increasing size.

7. The flossing tool of claim 1, wherein the coupling structure includes a pair of barbed spines extending opposite the projection member and the release mechanism includes an aperture in a top region of the cylindrical body configured to receive the pair of barbed spines.

8. A flossing kit, comprising:
a) a pair of floss handles;
b) a plurality of floss cartridges, each selectably coupleable to the pair of floss handles and including a length of floss fixedly coupled to a pair of tip members, wherein at least one of the pair of tip members of each floss cartridge includes a projection member that is sized to fit behind arch wires of a set of braces;
c) a cradle, including:
a first array of recessed slots sized and shaped to receive the plurality of floss cartridges; and
a second array of recessed slots oriented substantially orthogonal to the first array of recessed slots and sized and shaped to receive the pair of floss handles, such that the pair of floss handles, when so disposed rest between tip members and above lengths of floss of floss cartridges when floss cartridges are disposed within the first array.

9. The flossing kit of claim 8, further comprising a cover sized and shaped to envelop the cradle about all but one side.

10. The flossing kit of claim 8, wherein the floss handles and tip members are shaped and sized to be too large to fit behind an arch wire of a set of braces.

11. The flossing kit of claim 8, wherein the projection member is arched.

12. The flossing kit of claim 8, wherein the pair of floss handles each include a release mechanism configured to selectably couple to and selectably decouple from the tip floss cartridges and wherein each release mechanism includes a spring-loaded button disposed on a bottom surface of each of the floss handles, the button positioned and oriented such that it may be depressed by pressing the bottom surface of the floss handle against a surface.

13. The flossing kit of claim 8, wherein the tip members are swivel-ably coupleable to the flossing handles.

14. The flossing kit of claim 8, wherein the tip member having the projection member includes a shoulder having a graduated size, the shoulder being coupled to the projection member.

15. The flossing kit of claim 8, wherein the tip members are substantially collinear to the floss handles when coupled thereto.

16. A flossing kit, comprising:
a) a plurality of floss cartridges, each including:
a length of floss; and
a pair of tip members each sized larger than a typical spacing behind arch wires of a set of braces, each fixedly coupled to opposite ends of the length of floss and each including:
a coupling structure; and
a projection member opposite the coupling structure and coupled to the length of floss, wherein the projection member of at least one of the tip members is elongated and sufficiently narrow to be inserted into a typical spacing behind arch wires of a set of braces;
b) a pair of floss handles that each removably couple to one of the pair of tip members respectively, each floss handle including:
a cylindrical body substantially larger than a typical spacing behind arch wires of a set of braces, and
a release mechanism disposed within the cylindrical body that selectably couples to the associated coupling structure of the tip member and selectably disengages from the associated coupling structure of the associated tip member when triggered; and wherein each of the tip members are collinear with their associated floss handles when coupled thereto;
c) a cradle, including:
a first array of recessed slots sized and shaped to receive the plurality of floss cartridges; and
a second array of recessed slots oriented substantially orthogonal to the first array of recessed slots and sized and shaped to receive the pair of floss handles, such that the pair of floss handles, when so disposed rest between tip members and above lengths of floss of floss cartridges when floss cartridges are disposed within the first array; and
d) a cover sized and shaped to envelop the cradle about all but one side.

17. The flossing kit of claim 16, wherein the elongated projection member is arched and the release mechanism includes a swivel structure configured to permit the associated tip member to swivel when coupled thereto.

18. The flossing kit of claim 17, wherein the release mechanism includes a spring-loaded button disposed on a bottom surface of each of the floss handles, the button positioned and oriented such that it may be depressed by pressing the bottom surface of the floss handle against a surface.

19. The flossing kit of claim 18, wherein the coupling structure includes a pair of barbed spines extending opposite the projection member and the release mechanism includes an aperture in a top region of the cylindrical body configured to receive the pair of barbed spines and wherein the tip members are substantially collinear to the floss handles when coupled thereto.
